(19) United States
(12) Patent Application Publication
(10) Pub. No.: US 2017/0316851 A1
(43) Pub. Date: Nov. 2, 2017

(54) DATA CABLE AND METHOD FOR PRODUCING SUCH A DATA CABLE

(71) Applicant: LEONI KABEL GMBH, NUERNBERG (DE)

(72) Inventors: RAINER POEHMERER, WINKELHAID (DE); ERWIN KOEPPENDOERFER, SCHWABACH (DE); DOMINIK DORNER, PLEINFELD (DE); SEBASTIAN FREIMAN, GEORGENSGMUEND (DE)

(21) Appl. No.: 15/494,667

(22) Filed: Apr. 24, 2017

(30) Foreign Application Priority Data
Apr. 28, 2016 (DE) 102016207322.2

(51) Int. Cl. H01B 11/18; H01B 13/26; H01B 11/00

(52) U.S. Cl. CPC H01B 11/1826; H01B 11/002; H01B 13/2613

(57) ABSTRACT

A data cable has a specially arranged and embodied shielding foil. The shielding foil surrounds an insulated conductor and has multiple layers, including a conductive layer and at least one carrier layer on which the conductive layer is applied. The shielding foil is folded and has a fold around which the conductive layer is guided so that the conductive layer forms an upper face and a lower face. The shielding foil is wound around the insulated conductor. The shielding foil has multiple sequential windings that overlap in an overlap region in which the upper face in one of the multiple sequential windings makes contact with the lower face of a following one of the multiple sequential windings so as to form a continuous shielding configuration.

### CROSS-REFERENCE TO RELATED APPLICATION

This application claims the priority, under 35 U.S.C. §119, of German application DE 10 2016 207 322.2, filed Apr. 28, 2016; the prior application is herewith incorporated by reference in its entirety.

### BACKGROUND OF THE INVENTION

### Field of the Invention

The invention relates to a data cable and a method for producing such a data cable.

A data cable is used primarily for transmitting data or signals. The data cable contains for this purpose a number of usually insulated conductors by way of which electrical signals are directed. In order to improve the transmission characteristics of a data cable, in particular in the case of high frequencies, e.g. in the range of multiple Gigahertz, it is possible to shield the conductors against interference from the outside, in that the conductors are surrounded altogether, in groups or even individually by a shielding arrangement. Such a shielding arrangement is by way of example braided wire or a metal foil.

An ideal shielding arrangement is in this case is as far as possible continuous, in other words is not interrupted, so that the conductor for transmitting the data is completely encased by a conductive material and the currents that are induced into the shield can dissipate unhindered. In contrast, any holes or cut-outs in the shield lead in a disadvantageous manner to greater signal attenuation along the cable and also to an impaired shielding effect with respect to an emission of electromagnetic signals from the data cable.

It is fundamentally possible to use so-called laminated foils as a shield and the laminated foils are wound around the conductor. Such a shielding foil usually contains a metal layer that is applied to a synthetic material layer and as a consequence is embodied in a continuous conductive layer. However, when winding the conductor a region is automatically produced in which the shielding arrangement is interrupted and this has corresponding negative consequences for the transmission characteristics.

One disadvantage in the case of a laminated foil is still its limited mechanical robustness, in particular in comparison to a braid. The thin metal layer is frequently greatly loaded during operation as a result of repeated bending and/or torsion loading and easily destroyed, as a consequence of which the metal layer is interrupted in places and the advantageous electrical characteristics are lost over time.

### SUMMARY OF THE INVENTION

On this basis, it is an object of the invention to provide a data cable that on the one hand is shielded as much as possible and on the other hand is as robust as possible. Furthermore, a method is to be provided for producing such a cable.

The data cable is used in particular for high speed data transmission, by way of example for data rates in the Gbit range. In the case of such an application, it is particularly critical that the transmission characteristics are maintained since even small changes thereto can lead to a great reduction in the transmission quality. This lies significantly in the fact that the transmission characteristics, such as for example the signal attenuation, are frequency-dependent, wherein the extent of the dependency increases the higher the frequencies.

The data cable contains at least one insulated conductor that is embodied from a conductive material and is surrounded by an electrically insulating material. The insulated conductor is surrounded by a shielding foil that is embodied from multiple layers, namely at least one carrier layer on which a conductive layer is applied. Without limiting the generality, the carrier layer is also described herein under as the insulating layer. The insulating layer is produced from an electrically insulating material, preferably a synthetic material and is then also a synthetic material layer while the conductive layer in contrast is produced from an electrically conductive material, preferably from a metal. By way of example, the insulating layer is metalized or laminated. In one embodiment, the conductive layer and the insulating layer are adhered to one another, in other words connected in particular by an adhesive layer. Also shielding foils that contain multiple insulating layers and/or multiple conductive layers are fundamentally suitable.

The shielding foil is folded and contains a fold around which the conductive layer is guided so that the conductive layer forms an upper face and a lower face. In particular, the insulating layer is also folded and in fact in such a manner that the insulating layer lies within the fold and the conductive layer on the outside, in other words the conductive layer extends at the fold in the cross-section around the insulating layer. Overall, the shielding foil then forms two layers, namely an upper layer, in other words the outer layer with respect to the conductor, and a lower layer, in other words an inner layer with respect to the conductor, wherein the two layers are connected to one another at the fold. In the case of the folded insulating layer, the sections then lie in the two layers in particular against one another and in this manner form an insulating inner layer. In addition, so as to form a continuous shielding arrangement, the shielding foil is wound around the conductor and contains multiple sequential windings that overlap one another in an overlap region in which the lower layer lies on the upper layer and the upper face of the conductive layer in one of the windings is in contact with the lower face of the conductive layer of one of the following windings.

An essential advantage of the invention resides in particular in the fact that by virtue of the special design and arrangement of the shielding foil a particularly effective and at the same time robust shielding arrangement is achieved. The mechanical robustness, in other words in particular the robustness of the transmission parameters of the data cable with respect to bending/changing and torsion loadings, are in particular improved by virtue of the fact that the shielding foil is wound around and not attached in particular in a longitudinal manner. Such a winding arrangement is more advantageous in the mechanical respect than a longitudinally extending foil. Nonetheless, a winding arrangement in contrast offers traditionally poorer electrical characteristics since owing to the helix-type progression of the conductive layer induced currents in this case cannot dissipate in the shielding foil in the longitudinal direction of the cable but rather the currents must flow in the transverse direction. This disadvantage is however primarily avoided by folding the shielding foil and by the special overlapping arrangement so that overall a particularly robust and at the same time optimal shielding arrangement is achieved.

This is based on the observation that an unfolded foil does not have any conductive layer in the edge region and therefore sequential and overlapping windings are not contacted in an electrical manner in the overlap region. In contrast, by virtue of folding the shielding foil an edge region is formed in an advantageous manner with a defined conductive layer, namely the conductive layer that is wound around the fold and is then embodied accordingly in the edge region of the folded shielding foil. As a consequence, the upper face is connected in one winding in an electrically conductive manner and the lower face is connected in an electrically conductive manner in the subsequent winding, in other words a contacting arrangement that covers the windings is formed. As a result of these electrical contacting arrangement of sequential windings in the overlap region, induced currents can now dissipate in all directions, particularly also in the longitudinal direction of the data cable. As a consequence, the signal attenuation in particular is considerably improved, in other words reduced, particularly in the high frequency range.

It is preferred that the conductive layer is an outermost layer of the folded foil. In other words: the conductive layer faces outwards in the case of the folded shielding foil so that in this case it is possible to make contact with other conductive elements, for example with a ground wire and/or a further shielding arrangement. Above all, however, the conductive layer as the outermost layer renders it possible in a particularly simple manner to make contact in the overlap region since then automatically two sequential windings are contacted.

In an advantageous embodiment, the shielding foil is folded in the middle. In the original, unfolded state, the shielding foil is formed as a strip with a specific entire width and extends in a longitudinal direction. The term ‘folded in the middle’ is understood to mean in particular that the shielding foil is folded along the longitudinal direction at half the entire width so that the fold extends in the longitudinal direction and divides the shielding foil into two halves of equal width that lie in particular against one another in a covering manner. The two layers are then of equal width. Such a shielding foil that is folded in the middle has significant advantages when used in a winding process since the shielding foil can be provided in a particularly uniform manner on a disc in preparation for the winding process and in addition can be also be unwound in a particularly uniform manner. In the case of an unevenly folded shielding foil, in other words a foil that is not folded in the middle, there exists in contrast the risk of the shielding foil running unevenly onto the conductor, in general onto the sub-structure, and also the risk of the geometry varying in an uncontrolled manner. In contrast, a shielding foil that is folded in the middle can be applied in a smooth and controlled manner. Fundamentally, however, a shielding foil that is not folded in the middle and has layers of different widths is also suitable.

Preferably, the shielding foil is only folded once and therefore comprises only one fold. Fundamentally, however, shielding foils that have multiple folds and in particular parallel folds are also feasible and suitable.

The insulating layer generally contains an entire width that in an unfolded state has the same width as the shielding foil. In the folded state, the width of the shielding foil corresponds depending upon the position of the fold only to a part of the entire width and in the case of a middle fold to half the entire width.

In a suitable embodiment, the conductive layer extends over the entire width. The conductive layer is thus embodied in such a manner that it is spread completely over the entire insulating layer. In principle, it is feasible that the conductive layer contains holes; the conductive layer is however preferably embodied in a continuous manner and then covers the entire insulating layer. As a consequence, a particularly good shielding arrangement is ensured overall.

In a suitable variant, the conductive layer extends over less than the entire width and more than half the entire width. The conductive layer is thus embodied only in part over one of the two layers and not over the entire width of the corresponding layer. In this embodiment, the insulating layer is not completely provided with a conductive layer, as a consequence of which accordingly not as much conductive material is required. By virtue of providing the conductive layer over at least half the entire width, it is further ensured in an advantageous manner particularly in the case of a shielding foil that is folded in the middle that sequential windings also actually make contact with one another.

In a further suitable variant, the conductive layer extends on one of the faces, in other words on the upper face or the lower face, completely and on the other face only in part and in particular exactly in the overlap region. In other words: the conductive layer is formed completely on one face, then guided around the fold, and on the other face is only formed in part and in fact on the overlap region so that overall the conductive layer extends in the cross-section along the longitudinal direction in an approximate J-shaped manner. In the event that the lower face of the conductive layer is formed completely, a contact opportunity with the outside does not arise since only the insulating layer can be accessed from the outside. Conversely, in the case of a completely formed upper face, the insulating layer faces inwards. These embodiments render it possible to avoid contact from outside inwards and conversely.

In a first suitable embodiment, the shielding foil only contains a conductive layer and is by way of example embodied as a foil that is laminated on one face. As an alternative to such a shielding foil that contains only one conductive layer, a shielding foil that comprises two conductive layers is also suitable, wherein the two conductive layers are then applied to different sides of the insulating layer. The shielding foil is then by way of example embodied as a double-laminated foil where both sides of the insulating layer are covered in particular completely with a conductive layer.

Fundamentally, in the case of multiple conductive layers both embodiments that contains identical conductive layers and also embodiments that comprise different conductive layers are suitable. By way of example, in one variant that contains two conductive layers, one of the conductive layers is produced as a regular, conductive layer that is produced from metal and, in contrast, the other conductive layer is produced as a conductive layer that in comparison thereto has poorer conductive characteristics. In addition, one embodiment is also suitable where the carrier layer is produced from a material that has poor conductive characteristics. The term ‘poor conductive characteristics’ is understood to mean in particular ‘less conductive than metal’ and preferably a conductivity that is less by at least two powers of ten than that of the conductive layer or of conventional metals. By way of example, a layer that has poor conductive characteristics is produced from a polymer that has poor conductive characteristics.

The shielding foil in a preferred embodiment is folded in such a manner that the insulating layer lies within the conductive layer. This means that the upper face and the lower face of the conductive layer surround and quasi encompass the insulating layer. This produces in particular the advantage that the now inner-lying insulating layer of the shielding foil is shielded by the conductive layer and as a consequence is not located in the primary electrical field of the conductor. The dielectric characteristics of the insulated layer thus do not have any influence or at least have only an insignificant influence on the transmission characteristics of the data cable.

The advantage of shielding the insulating layer by the conductive layer is also produced accordingly on one face in the case of correspondingly forming the conductive layer in part on one of the faces as described above. If the conductive layer is mainly oriented inwards, then the insulating layer also does not make any significant contribution in this case to the transmission characteristics of the conductor. Therefore, in the case of an embodiment of the shielding foil that contains a conductive layer that is embodied only over a part of the entire width, at least the lower face, in other words the face pointing inwards and towards the conductor is completely embodied so that the insulating layer lies outside a region that is encompassed continuously by the conductive layer.

It is preferred that the data cable contains a wire shield that is arranged around the shielding foil and is contacted by the conductive layer. The wire shield is in particular a braided shield, in other words a C-shield or a spiral wire shield, in other words a D-shield. The wire shield is embodied from a conductive material. The wire shield contributes advantageously to the robustness of the data cable. Any deficiencies with respect to the electrical characteristics are of secondary importance as a result of the combination with the shielding foil. Generally, the wire shield is considerably more robust in comparison to the shielding foil and in particular is embodied in a comparatively solid but still bend-flexible manner.

In an expedient manner, the wire shield and the shielding foil are connected in an electrical manner, namely by a direct contact with the wire shield and the conductive layer so that the two components lie on the identical potential and a particularly effective shielding arrangement is achieved. In this case, it is not necessary to provide an intermediate layer between the wire shield and the shielding foil. Although in the case of repeated mechanical loading the conductive layer is subjected on occasions to greater frictional wear by the wire shield that is lying thereon, the special embodiment of the shielding foil means that such external frictional wear on the upper layer is advantageously insignificant for the electrical transmission characteristics since the conductive layer remains intact at least in the lower layer and is not subjected to frictional wear by the wire shield.

In one expedient embodiment, the data cable is embodied as a coaxial cable, wherein the conductor is an inner conductor and the shielding arrangement is an outer conductor. A coaxial cable is suitable in particular for high speed data transmission and profits in particular from a uniformly and continuously formed outer conductor.

In a further expedient embodiment, the data cable is embodied from more than one wire and contains multiple wires, in particular exactly one wire pair that contains two wires, wherein the shielding foil is wound around the wires so as to form a shielded wire bunch. The wires are wrapped or twisted around one another or alternatively guided parallel with one another. In addition to the embodiment as a shielded wire pair, an embodiment having four wires is particularly preferred, in other words a quad element, in particular a star quad that is surrounded by the shielding foil.

Apart from the above mentioned embodiments, the concept of the wound and folded shielding foil is suitable for any type of shielding arrangement in the case of a cable or a wire.

A data cable is quite particularly preferred where the conductive layer is an outermost layer and the shielding foil is wound directly around the insulated conductor and also the shielding foil is surrounded directly by a wire shield, in particular a C-shield or a D-shield. In this embodiment, the essentially above described advantages are combined in a particularly effective manner.

In the case of the method for producing a data cable, in particular as described above, at least one conductor is surrounded by a shielding foil that is embodied from multiple layers, namely at least from a carrier layer that without limiting the generality is also described as the insulating layer to which a conductive layer is applied. The shielding foil is folded and a fold is produced around which the conductive layer is guided so that an upper face and a lower face of the conductive layer are formed. The shielding foil is furthermore wound around the conductor and multiple sequential windings of the shielding foil are formed that overlap one another in an overlap region in which the upper face is contacted in one of the windings by the lower face of one of the following windings so that a continuous shielding arrangement is produced.

In an expedient further development, the fold in the shielding foil is produced and compressed in addition by way of a roller in particular prior to the winding procedure. As a consequence, the stability of the folded shielding foil, to be more precise of the fold, is considerably improved. In so doing, the roller is pushed by way of example by a resilient force against the shielding foil that has been folded with the aid of the roller. The roller is expediently a deflecting roller that is already used to deflect the shielding foil, for example at the foil inlet.

In a suitable embodiment, the folding procedure and the winding procedure are performed in separate steps. In particular, the fold is produced first so that an already folded shielding foil is then used during the winding procedure. The shielding foil is thus pre-folded in a pre-folding procedure and then, for example, stored until the winding procedure is performed in a separate method step.

In a suitable alternative, the shielding foil is folded during the winding procedure. In this case, the folding procedure is integrated into the winding procedure, as a consequence of which a completely unfolded shielding foil can be directed to the method and accordingly the amount of the value added of the method is increased. In order to assist the folding procedure, an additional folding tool is attached by way of example to the winding plate.

Other features which are considered as characteristic for the invention are set forth in the appended claims.

Although the invention is illustrated and described herein as embodied in a data cable and a method for producing such a data cable, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1 to 3 are diagrammatic, sectional views of an exemplary embodiment of a data cable along a longitudinal direction according to the invention; and

FIG. 4 is a cross-sectional view of the data cable in a transverse direction with respect to the longitudinal direction.

### DETAILED DESCRIPTION OF THE INVENTION

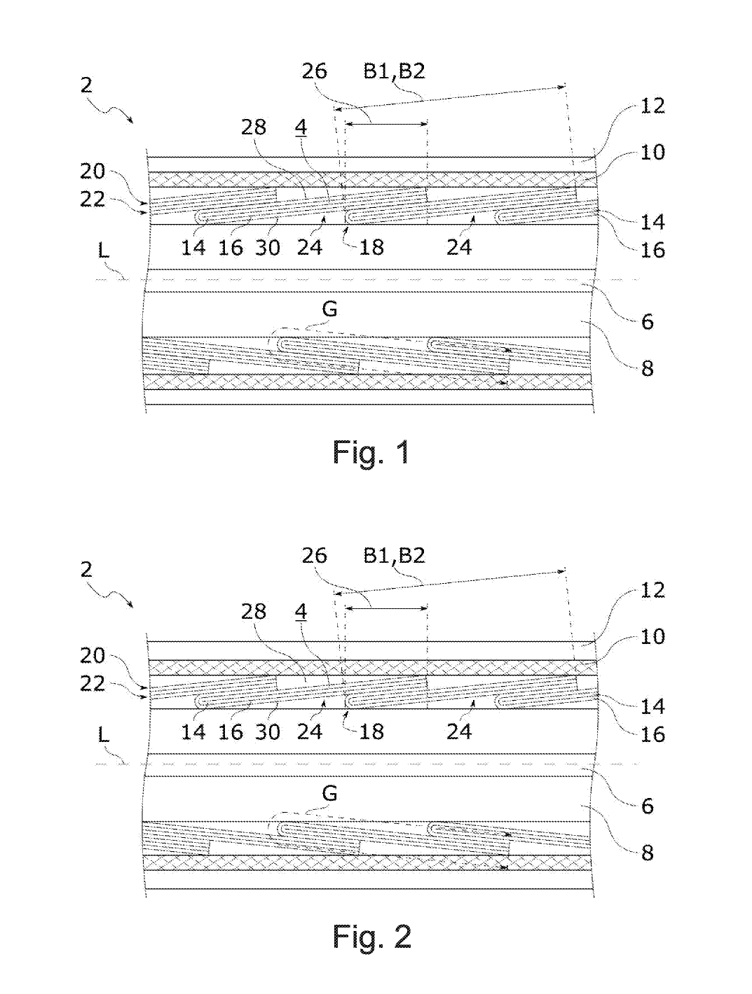

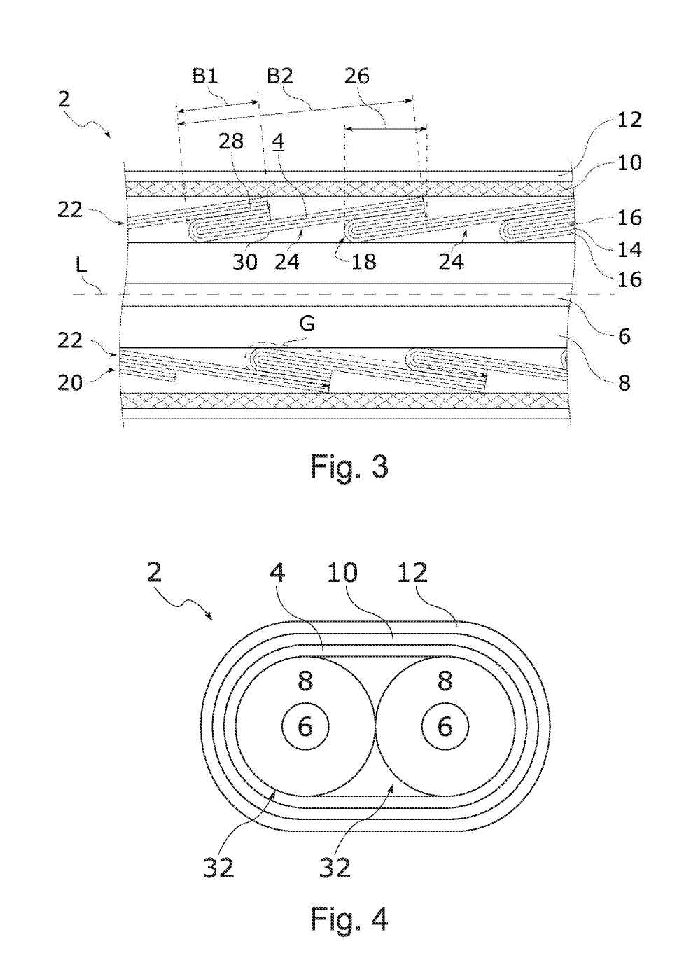

Referring now to the figures of the drawings in detail and first, particularly to FIGS. 1-3 thereof, there is shown in each case a sectional view of an exemplary embodiment of a data cable 2 along a longitudinal direction L thereof. FIG. 4 illustrates a cross-sectional view of the data cable 2 in a transverse direction with respect to the longitudinal direction L. In the case of the data cable 2, in general a folded shielding foil 4 is wound around an insulated conductor 6 in order to form a continuous shielding arrangement.

In the exemplary embodiments illustrated in FIGS. 1 to 3, the data cable is embodied as a coaxial cable for use in high speed data transmission, wherein the conductor 6 is an inner conductor that is surrounded by an insulation 8 that is used as a dielectric. The shielding foil 4 that is used in the exemplary embodiment as an outer conductor of the coaxial cable is wound directly around the dielectric. In addition, the shielding foil 4 is surrounded by a braided shield 10 around which an outer cover 12 of the data cable 2 is arranged. The braided shield 10 is in this case a wire braid and the outer cover 12 is produced from an insulating material. In an alternative, not illustrated, a spiral wire shield or in general a wire shield is arranged in lieu of the braided shield 10.

Particular importance is awarded to the special arrangement and embodiment of the shielding foil 4 that is illustrated in the three FIGS. 1 to 3 in three different variants. Differences arise in this case essentially in the type of fold produced and the precise embodiment of the shielding foil 4, as explained hereinunder.

In FIG. 1, the shielding foil 4 is a once-laminated foil that contains an insulating layer 14 and a conductive layer 16 that is applied thereto. The insulating layer 14 is embodied from an insulating material, preferably a synthetic material, and the conductive layer 16 is embodied from a conductive material, preferably from a metal. The shielding foil 4 is then in particular a metal-laminated synthetic material film. As a result of the folding procedure, a fold 18 is produced around which the conductive layer 16 is guided. In FIG. 1, the fold 18 is formed at half the entire width G of the shielding foil 4. As a consequence, a shielding foil 4 that is folded in the middle is produced, on which two layers 20, 22 are formed, the layers lying one on top of the other, namely an upper also outer layer 20 that is facing away from the conductor 6, and a lower also inner layer 22 that is facing towards the conductor 6. As a result of the middle fold, the layers 20, 22 contain in each case a width B1, B2 that corresponds to half the entire width G. By virtue of the middle fold, the shielding foil 4 is particularly simple to process and during the winding procedure produces a particularly uniform shielding arrangement.

An essential aspect that is achieved in all exemplary embodiments is the continuous shielding arrangement as a result of folding the shielding foil 4 in combination with the winding arrangement in lieu of the longitudinal fold. By virtue of the winding arrangement, multiple windings 24 are formed in the longitudinal direction L, wherein two sequential windings 24 overlap in the overlap region 26. In order to combine the mechanical flexibility of a wound shielding foil 4 with the advantageous electrical characteristics of a longitudinally folded shielding foil 4, the conductive layer 16 now contacts itself in the overlap region 26. This is achieved by virtue of the special folding arrangement in which the conductive layer 16 is guided around the fold 18 and is guided from the lower layer 22 into the upper layer 20. The conductive layer 16 thus contains an upper face 28 and a lower face 30. Where contact is made in overlapping windings, the upper face 28 of the conductive layer 16 makes contact in one of the windings 24 with the lower face 30 of the same conductive layer 16 in the following winding 24, and in fact exactly in the overlap region 26. As a consequence, eddy currents can dissipate in the longitudinal direction L even in the case of the wound shielding foil 4, as in the case of a longitudinally folded shielding foil 4 but now in an advantageous manner in combination with the improved mechanical flexibility of the wound arrangement.

In FIG. 1, the conductive layer 16 is formed over the total entire width G so that the folded insulating layer 14 is surrounded and encompassed by the conductive layer 16. As a consequence, the insulating layer 14 is shielded from the primary electrical field of the conductor 6 and contributes at the most in an insignificant manner to its transmission characteristics. Moreover, the conductive layer 16 is directly contacted by the braided shield 10. As a result of the folded embodiment, the amount of frictional wear on the conductive layer 16 of the upper layer 20 caused by the braided shield 10 is not critical since a continuous and effective shielding arrangement is still ensured by virtue of the conductive layer 16 in the lower layer 22.

FIG. 2 illustrates a variant of the data cable 2, wherein the upper face 28 of the conductive layer 16 contains a width B1 that is reduced in comparison to the example in FIG. 1. The conductive layer 16 is thus applied only in part over the entire width G to the insulating layer 14 but is applied to more than half the entire width G so that in the overlap region 26 it is ensured that overlapping windings can make contact in the conductive layer 16. FIG. 2 illustrates the upper face 28 exactly on the overlap region 26 so that the wound shielding foil 4 is insulated towards the outside and the conductive layer 16 is not contacted by the braided shield 10. In an alternative, not illustrated, the braided shield 10 is omitted. Fundamentally, as an alternative, it is also feasible to reverse the arrangement in such a manner that the conductive layer 16 faces outwards and the insulating layer 16 lies inwards on the insulation 8.

In the case of the variant illustrated in FIG. 3, a shielding foil 4 that is modified in two respects is used. On the one hand, the shielded foil 4 is laminated twice, in other words a conductive layer 16 is applied in each case to both sides of an individual insulating layer 14, wherein these two conductive layers 16 are not automatically connected to one another and also not automatically connected in an electrical manner to one another. On the other hand, the shielding foil 4 is not folded in the middle but merely folded in such a manner that one of the layers 20, 22, in this case the upper layer 20, is exactly as wide as the overlap region 26.

In all the illustrated exemplary embodiments, the conductive layer 16 is an outermost layer of the folded shielded foil 4, in other words the shielded foil is folded in such a manner that the conductive layer 16 faces outwards and the insulating layer 14 wraps around at least in part.

The different concepts that are described above with reference to exemplary embodiments with respect to the shielding foil 4, in other words in particular the widths B1, B2 of the layers 20, 22, the position of the fold 18, the in part or complete embodiment of the conductive layer 16, the arrangement and number of the layers and their orientation inwards or outwards are not limited to the three illustrated variants but rather can also be combined with one another in order to obtain further advantageous embodiments. It is thus possible, for example in FIGS. 1 and 2, to also use a double-laminated shielding foil 4 that contains two conductive layers 16.

In addition, the special embodiment and arrangement of the shielding foil 4 is not limited to use as an outer conductor in a coaxial cable. By way of example, FIG. 4 illustrates in a sectional view in a transverse manner with respect to the longitudinal direction L a data cable 2 that is embodied as a shielded wire pair having two wires 32 that are surrounded jointly by the folded shielding foil 4. The wires 32 can be either twisted around one another or alternatively guided in parallel with one another and not twisted. Variants that comprise more than two wires are also feasible.

1. A data cable, comprising:
at least one insulated conductor; and
a shielding foil surrounding said insulated conductor and having multiple layers, including a conductive layer and at least one carrier layer on which said conductive layer is applied, said shielding foil being folded and having a fold around which said conductive layer being guided so that said conductive layer forms an upper face and a lower face, said shielding foil being wound around said insulated conductor, and said shielding foil having multiple sequential windings that overlap in an overlap region in which said upper face in one of said multiple sequential windings makes contact with said lower face of a following one of said multiple sequential windings so as to form a continuous shielding configuration.

2. The data cable according to claim 1, wherein said conductive layer is an outermost layer of said shielding foil.

3. The data cable according to claim 1, wherein said shielding foil is folded in a middle.

4. The data cable according to claim 1, wherein said carrier layer has an entire width and said conductive layer extends over said entire width.

5. The data cable according to claim 1, wherein said carrier layer has an entire width and said conductive layer extends over less than said entire width and more than half of said entire width.

6. The data cable according to claim 1, wherein said conductive layer extends completely over one of said upper and lower faces and on the other one of said upper and lower faces only in said overlap region.

7. The data cable according to claim 1, wherein said shielding foil is folded such that said carrier layer lies within said conductive layer.

8. The data cable according to claim 1, further comprising a wire shield disposed around said shielded foil and making contact with said conductive layer.

9. The data cable according to claim 1, wherein:
the data cable is a coaxial cable; and
said conductor is an inner conductor and said continuous shielding configuration is an outer conductor.

10. The data cable according to claim 1, wherein:
the data cable contains multiple wires; and
said shielded foil is wound around said wires so as to form a shielded wire bunch.

11. The data cable according to claim 1,
wherein said conductive layer is an outermost layer;
wherein said shielding foil is wound directly around said insulated conductor; and
further comprising a wire shield directly surrounding said shielding foil.

12. The data cable according to claim 8, wherein said wire shield is a braided shield or a spiral wire shield.

13. The data cable according to claim 1, wherein the data cable contains exactly one wire pair having two wires.

14. The data cable according to claim 1, wherein the data cable is configured for use in high speed data transmission.

15. A method for producing a data cable, which comprises the steps of:
surrounding at least one insulated conductor with a shielding foil that is embodied from multiple layers including a conductive layer and at least one carrier layer to which the conductive layer is applied, the surrounding step including the following substeps:
folding the shielding foil which forms a fold around which the conductive layer is guided so that an upper face and a lower face of the conductive layer are defined;
winding the shielding foil around the insulated conductor; and
forming multiple sequential windings of the shielding foil that overlap in an overlap region in which the upper face in one of the sequential windings makes contact with the lower face of a following one of the sequential windings so that a continuous shielding configuration is formed.

16. The method according to claim 15, which further comprises guiding the fold of the shielding foil over a roller and compressing the fold.

17. The method according to claim 15, which further comprises performing the folding step and the winding step in separate steps.

18. The method according to claim 15, which further comprises folding the shielded foil during the winding step.
